(19) United States
(12) Patent Application Publication
(10) Pub. No.: US 2026/0296472 A1
(43) Pub. Date: Oct. 1, 2026

(54) VEHICLE NOTIFICATION APPARATUS, VEHICLE NOTIFICATION METHOD, AND VEHICLE NOTIFICATION SYSTEM

(71) Applicant: HONDA MOTOR CO., LTD., Tokyo (JP)

(72) Inventors: Masaki Maruyama, Wako-shi (JP); Ryo Iitaka, Wako-shi (JP)

(21) Appl. No.: 19/460,668

(22) Filed: Jan. 27, 2026

(30) Foreign Application Priority Data
Mar. 25, 2025 (JP) 2025-049355

(51) Int. Cl. B60W 50/14; G06V 20/58; G06V 20/59; G06V 40/16

(52) U.S. Cl. CPC B60W 50/14; G06V 20/58; G06V 20/597; G06V 40/161; B60W 2050/143; B60W 2420/403; B60W 2540/22; B60W 2554/4044

(57) ABSTRACT

A vehicle notification apparatus includes an object detection unit that detects an object around a vehicle, a recognition unit that recognizes, when an object is detected by the object detection unit, a direction of the object, an alarm control unit that controls a notification unit disposed in a vehicle cabin, and outputs an alarm sound that forms a sound image direction substantially aligned with the direction of the object recognized by the recognition unit, and a notification control unit capable of outputting a notification sound that forms a sound image in a predetermined direction when no object is detected by the object detection unit, and outputting a face direction instruction that instructs an occupant to turn the face in the sound image direction of the notification sound during the output of the notification sound.

### INCORPORATION BY REFERENCE

The present application claims priority under 35 U.S.C. § 119 to Japanese Patent Application No. 2025-049355 filed on Mar. 25, 2025. The content of the application is incorporated herein by reference in its entirety.

### BACKGROUND OF THE INVENTION

### Field of the Invention

The present invention relates to a vehicle notification apparatus, a vehicle notification method, and a vehicle notification system.

### Description of the Related Art

In recent years, efforts to provide access to sustainable transport systems that give consideration to people in vulnerable positions among traffic participants have become more active. To achieve this, the efforts are put into research and development to further improve traffic safety and convenience through research and development on active safety.

For example, conventionally, in a vehicle that outputs a warning sound from a direction of an object when approaching the object, a technique for training a directional cognitive degree of an occupant to the output warning sound has been known. Japanese Patent Laid-Open No. 2010-208606 discloses a technique that outputs a virtual sound using stereophonic sound in which a sound image localization direction is substantially aligned with an arrival direction of an operational sound associated with a predetermined vehicle operation, when no object has been detected around the vehicle, that is, in a situation where no attention alert is required.

In the technique related to active safety, outputting virtual sounds for cognitive learning on sound image direction is disclosed. However, although the cognitive ability for sound image direction of an occupant can be trained due to differences in the phase and sound pressure of notification sounds between the left and right ears of the occupant, there is such a problem that, in learning for directions where the perceived sound is similar such as right front and right rear, the cognitive learning on sound image direction cannot be sufficiently performed.

In order to solve the above-mentioned problem, an object of the present application is to improve the effect of cognitive learning on sound image direction. Furthermore, the present application contributes to the development of sustainable transport systems.

### SUMMARY OF THE INVENTION

An aspect for achieving the above-mentioned object is a vehicle notification apparatus including: an object detection unit that detects an object around a vehicle; a recognition unit that recognizes, when an object is detected by the object detection unit, a direction of the object; an alarm control unit that controls a notification unit disposed in a vehicle cabin, and outputs an alarm sound that forms a sound image direction substantially aligned with the direction of the object recognized by the recognition unit; and a notification control unit capable of outputting a notification sound that forms a sound image in a predetermined direction when no object is detected by the object detection unit, and outputting a face direction instruction that instructs an occupant to turn the face in the sound image direction of the notification sound during the output of the notification sound.

According to the aspect of the present invention, since the face is moved to face in the sound image direction of the notification sound, it is possible to improve the effect of cognitive learning on sound image direction.

### BRIEF DESCRIPTION OF THE DRAWINGS

FIG. 1 is a diagram showing the configuration of a vehicle;

FIG. 2 is a diagram showing the configuration of a vehicle notification apparatus;

FIG. 3 is a flowchart showing operation of a vehicle notification process in the vehicle notification apparatus;

FIG. 4 is a flowchart showing operation of a cognitive training process in the vehicle notification apparatus;

FIG. 5 is a flowchart showing operation of a notification sound control process in the vehicle notification apparatus;

FIG. 6 is an explanatory diagram showing a display example of a navigation screen; and

FIG. 7 is an explanatory diagram showing a display example of the navigation screen.

### DETAILED DESCRIPTION OF THE INVENTION

Hereinbelow, an embodiment will be described with reference to the drawings.

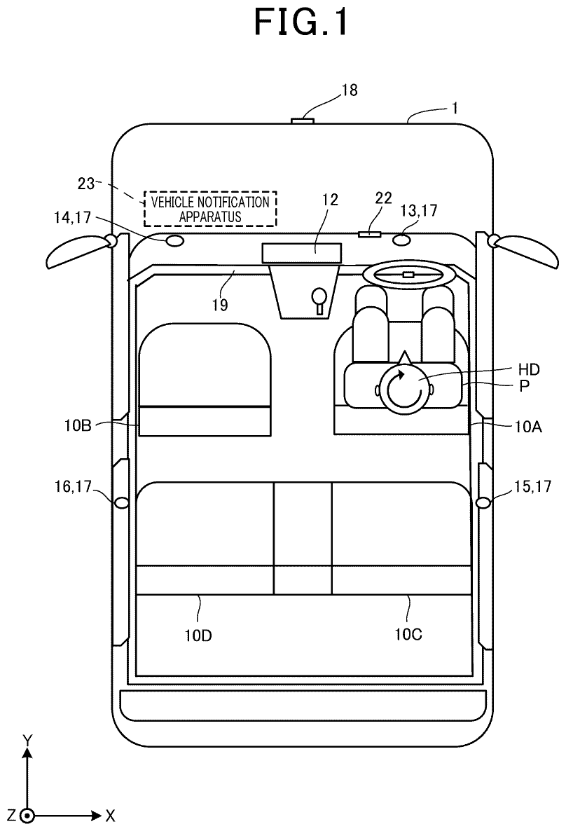

FIG. 1 shows an X-axis, a Y-axis, and a Z-axis. The X-axis, the Y-axis, and the Z-axis are perpendicular to each other. The Z-axis indicates the up-down direction. The X-axis and the Y-axis are parallel to the horizontal direction in a traveling state of a vehicle 1. The X-axis indicates the left-right direction as a vehicle-width direction. The Y-axis indicates the front-rear direction. A positive direction of the X-axis indicates the rightward direction. A positive direction of the Y-axis indicates the forward direction. A positive direction of the Z-axis indicates the upward direction.

### 1. Configuration of Vehicle

FIG. 1 is a diagram showing the configuration of the vehicle 1.

The vehicle 1 illustrated in FIG. 1 is a four-wheeled vehicle. The vehicle 1 includes a driver's seat 10A, a front passenger seat 10B, a rear right seat 10C, and a rear left seat 10D. In the vehicle 1 of FIG. 1, a situation in which a driver P is sitting in the driver's seat 10A is shown.

The vehicle 1 includes a touch panel 12. The touch panel 12 includes a display panel that displays characters and images and a touch sensor that detects contact with the display panel, the display panel and the touch sensor being superimposed or integrated.

The vehicle 1 includes speakers 13, 14, 15, 16. The speaker 13 outputs a sound to the driver P sitting in the driver's seat 10A. The speaker 14 outputs a sound to an occupant sitting in the front passenger seat 10B. The speaker 15 outputs a sound to an occupant sitting in the rear right seat 10C. The speaker 16 outputs a sound to an occupant sitting in the rear left seat 10D. Note that installation positions of the speakers 13, 14, 15, 16 are not limited to those in FIG. 1 and may be any positions where sounds can be output to the occupants sitting in the corresponding seats.

Hereinbelow, when the speakers 13, 14, 15, 16 are not distinguished from each other, the speakers 13, 14, 15, 16 are referred to as the “speaker 17” with reference numeral “17”.

The speaker 17 is a stereophonic sound speaker capable of forming a sound image at a designated position. The “designated position” refers to three-dimensional coordinates.

The speaker 17 is an example of the “notification unit”.

The vehicle 1 includes a front camera 18 that captures images forward of the vehicle 1. The front camera 18 is provided at a front part of the vehicle 1 and captures images forward of the vehicle 1. The front camera 18 captures images at predetermined time intervals when an ignition of the vehicle 1 is on or when an accessory power supply of the vehicle 1 is on. Each time the front camera 18 captures an image, the front camera 18 outputs, to a vehicle notification apparatus 23, image data of the captured image (hereinbelow, referred to as the “front-captured image”) obtained.

The vehicle 1 includes an ambient light 19 that is disposed surrounding a vehicle cabin. The ambient light 19 includes a plurality of light emitting diodes (LEDs). The vehicle notification apparatus 23 repeatedly performs, as light emission control of the ambient light 19, control that causes one or some of the LEDs in the ambient light 19 to emit light and then turns off the LEDs, while shifting the LED to be controlled. Since the ambient light 19 is disposed surrounding the vehicle cabin, when the light emission control of the ambient light 19 is performed, it is possible to enable the driver P to visually recognize light as if the light is circularly moving around the driver P.

A monitor camera 22 is provided. The monitor camera 22 is a camera that is provided at a predetermined position in the vehicle cabin of the vehicle 1 and captures images of the driver P sitting in the driver's seat 10A. An image capturing range of the monitor camera 22 is a range including at least the head HD of the driver P sitting in the driver's seat 10A. The monitor camera 22 captures images at predetermined time intervals when the ignition of the vehicle 1 is on or when the accessory power supply of the vehicle 1 is on. Each time the monitor camera 22 captures an image, the monitor camera 22 outputs, to the vehicle notification apparatus 23, image data of the captured image (hereinbelow, referred to as the “driver-captured image”) obtained.

The vehicle 1 includes the vehicle notification apparatus 23. The vehicle notification apparatus 23 is an apparatus that provides various notifications to the driver P through the speaker 17.

### 2. Configuration of Vehicle Notification Apparatus

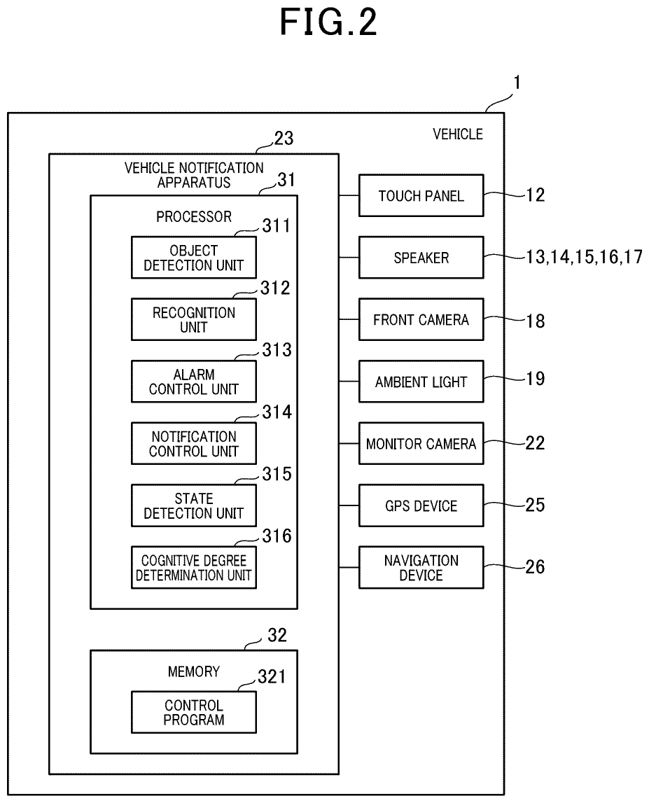

FIG. 2 is a diagram showing the configuration of the vehicle notification apparatus 23.

The vehicle notification apparatus 23 includes a processor 31 such as a central processing unit (CPU) or a micro-processing unit (MPU), a memory 32, and an interface circuit to which other devices and sensors are connected.

The processor 31 controls each unit of the vehicle notification apparatus 23 by reading and executing a control program 321 stored in the memory 32. The processor 31 functions as an object detection unit 311, a recognition unit 312, an alarm control unit 313, a notification control unit 314, a state detection unit 315, and a cognitive degree determination unit 316 by executing the control program 321 stored in the memory 32.

The memory 32 is a storage device that stores programs to be executed by the processor 31 and data to be processed by the processor 31. The memory 32 stores the control program 321 to be executed by the processor 31 and various other data. The memory 32 includes a nonvolatile storage area. The memory 32 also includes a volatile storage area and constitutes a work area of the processor 31. The memory 32 includes, for example, a read only memory (ROM) and a random access memory (RAM).

The control program 321 corresponds to the “program”.

The touch panel 12, the speaker 17, the front camera 18, the ambient light 19, the monitor camera 22, a GPS device 25, and a navigation device 26 are connected to the vehicle notification apparatus 23. Note that the devices connected to the vehicle notification apparatus 23 are not limited to these, and other devices such as a vehicle-to-vehicle communication device that performs vehicle-to-vehicle communication, a global navigation satellite system (GNSS) unit, a rear camera, and a vehicle speed sensor may be connected to the vehicle notification apparatus 23.

The GPS device 25 is a device that acquires position information of the vehicle 1.

The navigation device 26 includes a computer including a processor and a memory, and provides route guidance to a destination set by a user of the vehicle 1. In accordance with prior art, the navigation device 26 acquires information on the current position of the vehicle 1 using a GNSS sensor (not shown) and provides route guidance to the destination based on map information stored in the memory. The navigation device 26 displays an image on the touch panel 12.

As described above, the processor 31 of the vehicle notification apparatus 23 functions as the object detection unit 311, the recognition unit 312, the alarm control unit 313, the notification control unit 314, the state detection unit 315, and the cognitive degree determination unit 316.

The object detection unit 311 detects an object around the vehicle 1. Examples of the object include another vehicle, a pedestrian, and a fixed object. For example, the object detection unit 311 detects an object in the front-captured image based on image data received from the front camera 18. The object detection unit 311 detects an object in the front-captured image by performing pattern matching or color-based image processing on the front-captured image. Note that data required for object detection (e.g., shape data and color data) is stored in the memory 32 for each type of object to be detected.

When an object is detected by the object detection unit 311, the recognition unit 312 recognizes the direction of the object. The “direction of the object” refers to the direction of the object relative to the position of the driver P when the vehicle 1 is viewed from the top. Specifically, the object detection unit 311 recognizes the direction of the object in the front-captured image relative to the position of the driver P in the driver-captured image, based on image data received from the front camera 18 and the monitor camera 22.

The alarm control unit 313 controls the notification unit disposed in the vehicle cabin and outputs an alarm sound that forms a sound image direction substantially aligned with the direction of the object recognized by the recognition unit 312. The “sound image direction substantially aligned with the direction of the object” refers to the direction relative to the position of the driver P. Specifically, the alarm control unit 313 controls the speaker 17 as the “notification unit” and outputs an alarm sound. In addition, “being substantially aligned” is a concept that includes perfect alignment and alignment that is not perfect alignment but within a certain range of error (within a range that can be considered as approximate alignment). For example, the alarm control unit 313 outputs an alarm sound that forms a sound image direction in a direction that is perfectly aligned with the direction of the object recognized by the recognition unit 312 or in a direction within an angular range of ±5 degrees from the direction of the object relative to the position of the driver P. Hereinbelow, one direction and another direction being substantially aligned means that the one direction and the other direction fall within the angular range of ±5 degrees. However, a specific value of the error is not limited to this.

The notification control unit 314 is capable of outputting a notification sound that forms a sound image in a predetermined direction when no object is detected by the object detection unit 311, and outputting a face direction instruction that instructs the driver P to turn the face in the sound image direction of the notification sound during the output of the notification sound. The “predetermined direction” is the direction relative to the position of the driver P.

In the present embodiment, when any of the following nine notification conditions is established, the notification control unit 314 performs output control of the notification sound of the type corresponding to the established notification condition.

A first notification condition is that it is a timing immediately after an ignition power supply is turned ON.

A second notification condition is that the vehicle 1 is in a stage of pulling away from a parking lot.

A third notification condition is that a certain period of time elapses after the vehicle 1 starts moving.

A fourth notification condition is that a predetermined time elapses after a departure from a stopover point on the way to a destination.

A fifth notification condition is that a predetermined signal is received from a pre-registered Internet of Things (IoT) device. For example, the vehicle 1 has a communication function and is capable of receiving the predetermined signal from a home appliance connected to an internet line, such as a refrigerator, a washing machine, an air conditioner, a water heater, and a robot vacuum cleaner as the IoT device.

A sixth notification condition is that the vehicle 1 is at a stop in P-range.

A seventh notification condition is that the health status of the driver P is a fatigued state.

An eighth notification condition is that the vehicle 1 arrives at the destination.

A ninth notification condition is that it is a timing immediately after the ignition power supply is turned OFF.

When the first notification condition is established, the notification control unit 314 outputs, as the notification sound, a sound effect such as “boom” so as to form a sound image in a light emission direction of the LED of the ambient light 19.

When the second notification condition is established, the notification control unit 314 outputs, as the notification sound, a sound effect such as “beep” so as to form a sound image in a direction for the driver P to confirm safety (front and rear).

When the third notification condition is established, the notification control unit 314 outputs, as the notification sound, a sound effect such as “pop-pop-pop” so as to form a sound image in the direction of a departure point, and outputs, as the notification sound, a sound effect such as “beep-beep-beep” so as to form a sound image in the direction of a destination point.

When the fourth notification condition is established, the notification control unit 314 outputs, as the notification sound, a voice reading aloud a stay time at the stopover point so as to form a sound image in the direction of the departure point. For example, the notification control unit 314 outputs, as the notification sound, a voice such as “having stayed for 15 minutes”.

When the fifth notification condition is established, the notification control unit 314 outputs, as the notification sound, a voice with a content corresponding to a signal received from the IoT device so as to form a sound image in the direction of the departure point. For example, the notification control unit 314 outputs, as the notification sound, a voice such as “the robot vacuum cleaner seems unable to move”.

When the sixth notification condition is established, the notification control unit 314 outputs, as the notification sound, a voice reading aloud information about a nearby landmark so as to form a sound image in the direction of the landmark. Specifically, the notification control unit 314 acquires current position information from the GPS device 25 and acquires map information from the navigation device 26, and identifies a landmark near the current position. Then, the notification control unit 314 acquires information about the identified landmark through the internet line and outputs the acquired landmark information as the notification sound. Note that, as the notification sound output when the sixth notification condition is established, a voice that reminds the occupant of the relevant landmark may be output. For example, when there is a zoo as the nearby landmark, an animal sound may be output as the notification sound.

When the seventh notification condition is established, the notification control unit 314 outputs, as the notification sound, a voice reading aloud information about a nearby rest area so as to form a sound image in the direction of the rest area. Specifically, the notification control unit 314 acquires current position information from the GPS device 25 and acquires map information from the navigation device 26, and identifies a rest area near the current position. Then, the notification control unit 314 acquires information about the identified rest area through the internet line and outputs the acquired rest area information as the notification sound. Examples of the rest area include a park, a restaurant, and a roadside station.

When the eighth notification condition is established, the notification control unit 314 outputs, as the notification sound, a sound effect such as “beep” so as to form a sound image in the direction for the driver P to confirm safety (front and rear).

When the ninth notification condition is established, the notification control unit 314 outputs, as the notification sound, a sound effect such as “boom” so as to form a sound image in the light emission direction of the LED of the ambient light 19.

In the present embodiment, when any of the nine notification conditions described above is established, the notification control unit 314 is capable of executing output control of the face direction instruction corresponding to the established notification condition.

When the first notification condition is established, the notification control unit 314 is capable of executing light emission control of the ambient light 19 as the face direction instruction.

When the second notification condition is established, the notification control unit 314 is capable of executing, as the face direction instruction, a voice output such as “please turn your face toward the sound for safety confirmation” from the speaker 17.

When the third notification condition is established, the notification control unit 314 is capable of executing, as the face direction instruction, a voice output such as “please turn your face toward the sound” from the speaker 17.

When the fourth notification condition is established, the notification control unit 314 is capable of executing, as the face direction instruction, a voice output such as “please turn your face toward the sound” from the speaker 17.

When the fifth notification condition is established, the notification control unit 314 is capable of executing, as the face direction instruction, a voice output such as “please turn your face toward the sound” from the speaker 17.

When the sixth notification condition is established, the notification control unit 314 is capable of outputting, as the face direction instruction, an arrow indicating the landmark direction and textual information such as “please turn your face in the arrow direction” to cause the driver P to turn the face toward the landmark on the touch panel 12.

When the seventh notification condition is established, the notification control unit 314 is capable of outputting, as the face direction instruction, an arrow indicating the rest area direction and textual information such as “please turn your face in the arrow direction” to cause the driver P to turn the face toward the rest area on the touch panel 12.

When the eighth notification condition is established, the notification control unit 314 is capable of executing, as the face direction instruction, a voice output such as “please turn your face toward the sound for safety confirmation” from the speaker 17.

When the ninth notification condition is established, the notification control unit 314 is capable of executing light emission control of the ambient light 19 as the face direction instruction.

In this manner, the notification control unit 314 is capable of executing the face direction instruction through the light emission control using the ambient light 19, the voice output control using the speaker 17, and the display control using the touch panel 12.

The state detection unit 315 detects the face direction of the driver P. Specifically, the state detection unit 315 detects the face direction of the driver P based on an image analysis result for the driver-captured image captured by the monitor camera 22. Note that the state detection unit 315 may detect the face direction of the driver P based on the distance and angle of movement of characteristic points of the driver P such as the neck, nose, and ears.

The notification control unit 314 changes a mode of at least one of the notification sound and the face direction instruction based on the relationship between the sound image direction of the notification sound and the face direction of the driver P.

When the sound image direction of the notification sound and the face direction of the driver P are not substantially aligned within a predetermined time after the notification sound is output, the notification control unit 314 extends an output time of the notification sound. Specifically, the notification control unit 314 outputs the notification sound for a time corresponding to a directional cognitive degree of the driver P. When the sound image direction of the notification sound and the face direction of the driver P are not substantially aligned by the time the output of the notification sound ends, the output of the notification sound is extended. The directional cognitive degree is an indicator showing the degree to which the driver P cognizes the sound image direction of the voice output from the speaker 17. Details of the directional cognitive degree will be described further below.

The notification control unit 314 continuously outputs the notification sound until the sound image direction of the notification sound and the face direction of the driver P are substantially aligned. Specifically, the notification control unit 314 extends the output time of the notification sound until the sound image direction of the notification sound and the face direction of the driver P are substantially aligned.

When the sound image direction of the notification sound and the face direction of the driver P are not substantially aligned within the predetermined time after the notification sound is output, the notification control unit 314 again outputs the face direction instruction with its mode changed. Specifically, when the notification control unit 314 is providing the face direction instruction through the light emission control using the ambient light 19, the notification control unit 314 changes light emission color of the LED. When the notification control unit 314 is providing the face direction instruction through the voice output control using the speaker 17, the notification control unit 314 changes the tone of the voice. When the notification control unit 314 is providing the face direction instruction through the display control using the touch panel 12, the notification control unit 314 changes the display color and the display range.

Note that a change to a face direction instruction of a mode using a different member may be made.

The cognitive degree determination unit 316 determines the directional cognitive degree of the driver P to the notification sound. In the present embodiment, as the directional cognitive degree, three cognitive levels including “high”, “medium”, and “low” are provided. “High” indicates that the driver P cognizes the sound image direction of the voice output from the speaker 17 to the highest degree. “Medium” indicates that the driver P cognizes the sound image direction of the voice output from the speaker 17 to the highest degree after “high”. “Low” indicates that the driver P cognizes the sound image direction of the voice output from the speaker 17 to the lowest degree.

The cognitive degree determination unit 316 determines the directional cognitive degree based on an elapsed time from when the notification sound is output to when the sound image direction of the notification sound and the face direction of the driver P are substantially aligned. The cognitive degree determination unit 316 determines the directional cognitive degree to be higher as the elapsed time from when the notification sound is output to when the sound image direction of the notification sound and the face direction of the driver P are substantially aligned decreases. Hereinbelow, the elapsed time from when the notification sound is output to when the sound image direction of the notification sound and the face direction of the driver P are substantially aligned may be simply referred to as the “elapsed time”.

The cognitive degree determination unit 316 determines the directional cognitive degree based on a face direction angle when the sound image direction of the notification sound and the face direction of the driver P are substantially aligned. The cognitive degree determination unit 316 determines the directional cognitive degree to be higher as an error between the sound image direction of the notification sound and the face direction of the driver P when the sound image direction of the notification sound and the face direction of the driver P are substantially aligned decreases. That is, the cognitive degree determination unit 316 determines the directional cognitive degree to be higher as an angle between the sound image direction of the notification sound and the face direction of the driver P relative to the position of the face of the driver P when the sound image direction of the notification sound and the face direction of the driver P are substantially aligned decreases. Hereinbelow, the angle between the sound image direction of the notification sound and the face direction of the driver P relative to the position of the face of the driver P when the sound image direction of the notification sound and the face direction of the driver P are substantially aligned may be simply referred to as the “angle”.

The notification control unit 314 changes the mode of at least one of the notification sound and the face direction instruction when the directional cognitive degree determined by the cognitive degree determination unit 316 is equal to or higher than a predetermined threshold. Specifically, the notification control unit 314 changes the mode of at least one of the notification sound and the face direction instruction when the cognitive level is “high”.

When the directional cognitive degree determined by the cognitive degree determination unit 316 is equal to or higher than the predetermined threshold, the notification control unit 314 outputs the notification sound without outputting the face direction instruction. Specifically, when the cognitive level is “high”, the notification control unit 314 is capable of outputting the notification sound, but does not output the face direction instruction. When the cognitive level is “medium” and “low”, the notification control unit 314 is capable of outputting both the notification sound and the face direction instruction.

When the directional cognitive degree determined by the cognitive degree determination unit 316 is equal to or higher than the predetermined threshold, the notification control unit 314 changes the length of the output time of the notification sound. Specifically, the notification control unit 314 sets the output time of the notification sound to 15 seconds when the cognitive level is “low”, to 10 seconds when the cognitive level is “medium”, and to 5 seconds when the cognitive level is “high”.

When the directional cognitive degree determined by the cognitive degree determination unit 316 is equal to or higher than the predetermined threshold, the notification control unit 314 reduces the frequency of outputting the notification sound. Specifically, when the cognitive level is “high”, the notification control unit 314 outputs the notification sound when the notification sound has not been output at the previous notification condition establishment.

### 3. Operation of Vehicle Notification Apparatus

Next, operation of the vehicle notification apparatus 23 according to the present embodiment will be described.

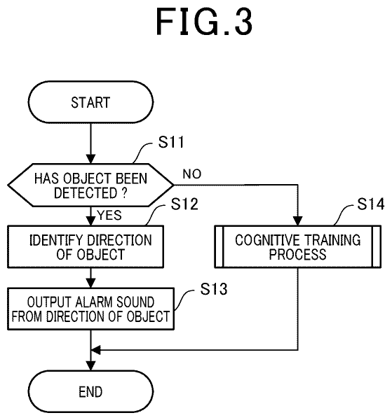

FIG. 3 is a flowchart showing operation of a vehicle notification process in the vehicle notification apparatus 23. The vehicle notification process is a process periodically performed by the processor 31 of the vehicle notification apparatus 23.

The processor 31 determines whether an object has been detected around the vehicle 1 (step S11).

Step S11 corresponds to the “object detection step”.

Next, when the object has been detected around the vehicle 1, the processor 31 identifies the direction of the object detected in step S11 (step S12).

Step S12 corresponds to the “recognition step”.

Then, the processor 31 outputs an alarm sound from the direction of the object identified in step S12 (step S13), and finishes the vehicle notification process.

Step S13 corresponds to the “alarm control step”.

In addition, when no object has been detected around the vehicle 1 in step S11, the processor 31 performs a cognitive training process for improving the directional cognitive ability of the driver P (step S14), and finishes the vehicle notification process.

Step S11 is executed by the object detection unit 311 of the processor 31.

Step S12 is executed by the recognition unit 312 of the processor 31.

Step S13 is executed by the alarm control unit 313 of the processor 31.

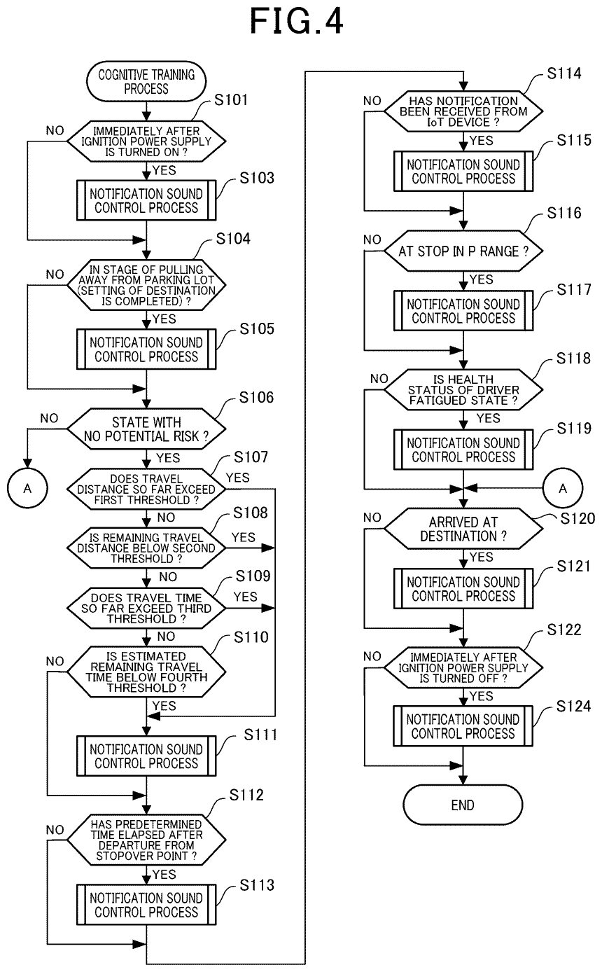

FIG. 4 is a flowchart showing operation of the cognitive training process in the vehicle notification apparatus 23.

The processor 31 determines whether it is the timing immediately after the ignition power supply is turned ON, that is, whether the first notification condition is established (step S101). When it is not the timing immediately after the ignition power supply is turned ON, a shift to step S104 is made.

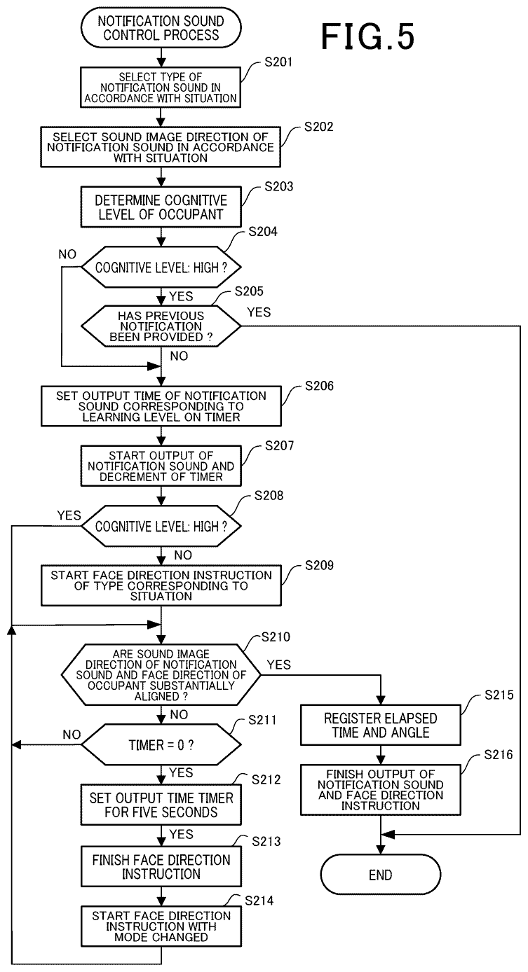

When it is the timing immediately after the ignition power supply is turned ON, the processor 31 performs a notification sound control process (step S103). The notification sound control process will be described further below with reference to FIG. 5.

Step S103 corresponds to the “notification control step”.

The processor 31 determines whether the vehicle 1 is in the stage of pulling away from the parking lot, that is, whether the second notification condition is established (step S104). Specifically, the processor 31 determines that the vehicle 1 is in the stage of pulling away from the parking lot when a destination is set in the navigation device 26. When the vehicle 1 is not in the stage of pulling away from the parking lot, a shift to step S106 is made. When it is determined that the vehicle 1 is in the stage of pulling away from the parking lot, the processor 31 performs the notification sound control process (step S105).

Step S105 corresponds to the “notification control step”.

The processor 31 determines the presence or absence of a potential risk and determines whether the vehicle 1 is in a safe state with no potential risk (step S106). Specifically, the processor 31 determines that the vehicle 1 is in the safe state with no potential risk when all of the following four safety conditions are satisfied.

A first safety condition is that a steering angle of the vehicle 1 is less than a predetermined value. The processor 31 acquires the steering angle of the vehicle 1 from a steering angle sensor provided on the vehicle 1.

A second safety condition is that a turn signal provided on the vehicle 1 is not blinking.

A third safety condition is that the touch panel 12 is not being operated.

A fourth safety condition is that the front-captured image does not include a sidewalk provided with neither a step nor a guardrail between the sidewalk and a roadway.

When the vehicle 1 is not in the safe state with no potential risk, the processor 31 shifts to step S120.

When the vehicle 1 is in the safe state with no potential risk, the processor 31 determines whether a certain period of time has elapsed after the movement start of the vehicle 1, that is, whether the third notification condition is established by performing processes of steps S107 to S110. First, the processor 31 determines whether a travel distance so far exceeds a first threshold (step S107). The “travel distance so far” refers to the travel distance from when the destination is set in the navigation device 26. Information on the travel distance so far is acquired from the navigation device 26. When the travel distance so far exceeds the first threshold, the processor 31 performs the notification sound control process (step S111).

Step S111 corresponds to the “notification control step”.

When the travel distance so far does not exceed the first threshold, the processor 31 determines whether a remaining travel distance to the destination set in the navigation device 26 is below a second threshold (step S108). Information on the remaining travel distance to the destination is acquired from the navigation device 26. When the remaining travel distance is below the second threshold, a shift to step S111 is made.

When the remaining travel distance is not below the second threshold, the processor 31 determines whether a travel time so far exceeds a third threshold (step S109). Information on the travel time so far is acquired from the navigation device 26. When the travel time so far exceeds the third threshold, a shift to step S111 is made.

When the travel time so far does not exceed the third threshold, the processor 31 determines whether an estimated remaining travel time to the destination is below a fourth threshold (step S110). Information on the estimated remaining travel time to the destination is acquired from the navigation device 26. When the estimated remaining travel time to the destination is below the fourth threshold, a shift to step S111 is made.

When the estimated remaining travel time to the destination is not below the fourth threshold, the processor 31 determines whether a predetermined time has elapsed after a departure from a stopover point visited on the way to the destination, that is, whether the fourth notification condition is established (step S112). When the predetermined time has elapsed after the departure from the stopover point on the way to the destination, the processor 31 performs the notification sound control process (step S113).

Step S113 corresponds to the “notification control step”.

When the predetermined time has not elapsed after the departure from the stopover point on the way to the destination, the processor 31 determines whether a predetermined signal has been received from the pre-registered IoT device, that is, whether the fifth notification condition is established (step S114). When the predetermined signal has been received from the IoT device, the processor 31 performs the notification sound control process (step S115).

Step S115 corresponds to the “notification control step”.

When the predetermined signal has not been received from the IoT device, the processor 31 determines whether the vehicle 1 is at a stop in P range, that is, whether the sixth notification condition is established (step S116). Being at a stop in P range is assumed to be, for example, a state waiting a long time at a traffic light or a state waiting at a railroad crossing. When the vehicle 1 is at a stop in P range, the processor 31 performs the notification sound control process (step S117).

Step S117 corresponds to the “notification control step”.

When the vehicle 1 is not at a stop in P range, the processor 31 determines whether a health status of the driver P is a fatigued state, that is, whether the seventh notification condition is established (step S118). Information on the health state of the driver P is acquired from a terminal device carried by the driver P. For example, the terminal device stores information such as a footstep count, a heart rate, and a sleeping time of the driver P as the health state. In step S118, when a parameter of the health state acquired from the terminal device exceeds a predetermined threshold, the driver P is determined to be in a fatigued state. For example, when the footstep count is high, when the heart rate is high for a long time, or when the sleeping time is short, the driver P is determined to be in a fatigued state as a state with strong fatigue or drowsiness. When the health status of the driver P is a fatigued state, the processor 31 performs the notification sound control process (step S119).

Step S119 corresponds to the “notification control step”.

When the health status of the driver P is not a fatigued state, the processor 31 determines whether the vehicle 1 has arrived at the destination, that is, whether the eighth notification condition is established (step S120). When the vehicle 1 has arrived at the destination, the processor 31 performs the notification sound control process (step S121).

Step S121 corresponds to the “notification control step”.

When the vehicle 1 has not arrived at the destination, the processor 31 determines whether it is the timing immediately after the ignition power supply is turned OFF, that is, whether the ninth notification condition is established (step S122). When it is not the timing immediately after the ignition power supply is turned OFF, the cognitive training process is finished without any further step.

When it is the timing immediately after the ignition power supply is turned OFF, the processor 31 performs the notification sound control process (step S124).

Step S124 corresponds to the “notification control step”.

FIG. 5 is a flowchart showing operation of the notification sound control process in the vehicle notification apparatus 23.

The processor 31 selects the type of notification sound in accordance with the established notification condition (step S201) and determines the sound image direction of the notification sound (step S202). The type and the sound image direction of the notification sound corresponding to the established notification condition are as described above.

The processor 31 determines the cognitive level of the driver P (step S203).

Specifically, the processor 31 determines the cognitive level of the driver P based on a reaction history of the driver P at past notification sound outputs. As the reaction history of the driver P at the past notification sound outputs, the elapsed time and the angle are stored in the memory 32.

For example, the processor 31 calculates a mean value of the elapsed time and a mean value of the angle at the past notification sound outputs. Then, the processor 31 determines whether the history of the elapsed time is a first time pattern in which the mean value of the elapsed time is smaller than a specific threshold or a second time pattern in which the mean value of the elapsed time is equal to or larger than the specific threshold. In addition, the processor 31 determines whether the history of the angle is a first angle pattern in which the mean value of the angle is smaller than a specific threshold or a second angle pattern in which the mean value of the angle is equal to or larger than the specific threshold. When the history of the elapsed time and the history of the angle at the past notification sound outputs are the first time pattern and the first angle pattern, the processor 31 determines that the cognitive level is “high”. When the history of the elapsed time and the history of the angle at the past notification sound outputs are the first time pattern and the second angle pattern or the second time pattern and the first angle pattern, the processor 31 determines that the cognitive level is “medium”. When the history of the elapsed time and the history of the angle at the past notification sound outputs are the second time pattern and the second angle pattern, the processor 31 determines that the cognitive level is “low”.

The processor 31 determines whether the cognitive level of the driver P determined in step S203 is “high” (step S204). When the cognitive level is “high”, the processor 31 determines whether the notification sound has been output at the previous notification condition establishment (step S205). Specifically, the processor 31 sets a flag when the notification sound is output, and determines that the notification sound has been output at the previous notification condition establishment by confirming that the flag is set when the notification condition is established. When it is determined that the notification sound has been output at the previous notification condition establishment, the processor 31 resets the flag.

When it is determined in step S205 that the notification sound has been output at the previous notification condition establishment, the processor 31 finishes the notification sound control process without any further step. In this manner, when the cognitive level of the driver P is “high” and the notification sound has been output at the previous notification condition establishment, output of the notification sound is not performed. That is, the frequency of outputting the notification sound is reduced when the cognitive level of the driver P is “high”, compared to when the cognitive level of the driver P is “medium” or “low”.

When it is determined in step S204 that the cognitive level of the driver P is “medium” or “low” or when it is determined in step S205 that the notification sound has not been output at the previous notification condition establishment, the processor 31 sets the output time of the notification sound corresponding to the cognitive level on a timer (step S206). Specifically, when the cognitive level of the driver P is “high”, the processor 31 sets the timer for 5 seconds as the output time. When the cognitive level of the driver P is “medium”, the processor 31 sets the timer for 10 seconds as the output time. When the cognitive level of the driver P is “low”, the processor 31 sets the timer for 15 seconds as the output time.

The processor 31 outputs the notification sound selected in step S201 so as to form a sound image in the direction selected in step S202, and starts a decrement process of the timer set in step S206 (step S207).

The processor 31 determines whether the cognitive level of the driver P determined in step S203 is “high” (step S208). When the cognitive level of the driver P is “medium” or “low”, the processor 31 starts the face direction instruction of the type corresponding to the established notification condition (step S209). The type of face direction instruction corresponding to the established notification condition is as described above. When the cognitive level of the driver P is “high”, the processor 31 does not perform the process in step S209 and shifts to step S210. That is, when the cognitive level of the driver P is “high”, the face direction instruction is not provided.

The processor 31 determines whether the sound image direction of the notification sound being output and the face direction of the driver P are substantially aligned (step S210). When the sound image direction of the notification sound being output and the face direction of the driver P are not substantially aligned, the processor 31 determines whether the timer has reached zero (step S211). When the timer is not zero, a shift to step S210 is made.

When the timer has reached zero, the processor 31 sets the timer for 5 seconds (step S212). Then, the processor 31 finishes the face direction instruction when the face direction instruction is being executed (step S213), starts the face direction instruction with its mode changed (step S214), and shifts to step S210.

In step S210, when the sound image direction of the notification sound being output and the face direction of the driver P are substantially aligned, the processor 31 stores the elapsed time and the angle as the reaction history (step S215), and finishes the output of the notification sound and the face direction instruction (step S216).

Steps S205 to S209, S212, S214 are executed by the notification control unit 314 of the processor 31.

Step S210 is executed by the state detection unit 315 of the processor 31.

Step S203 is executed by the cognitive degree determination unit 316 of the processor 31.

As described above, in the first embodiment, the vehicle notification apparatus 23 includes the object detection unit 311, the recognition unit 312, the alarm control unit 313, and the notification control unit 314. The object detection unit 311 detects an object around the vehicle 1. When an object is detected by the object detection unit 311, the recognition unit 312 recognizes the direction of the object. The alarm control unit 313 controls the speaker 17 disposed in the vehicle cabin, and outputs an alarm sound that forms a sound image direction substantially aligned with the direction of the object recognized by the recognition unit 312. The notification control unit 314 is capable of outputting a notification sound that forms a sound image in a predetermined direction when no object is detected by the object detection unit 311, and outputting a face direction instruction that instructs the driver P to turn the face in the sound image direction of the notification sound during the output of the notification sound.

Accordingly, the driver P moves the head when the notification sound is playing by providing an instruction to turn the face in the sound image direction of the notification sound that notifies direction using the sound image. This makes it possible to improve the learning effect of directional cognitive degree.

Specifically, by the driver P moving the head, differences in the phase and sound pressure of the notification sound can be created between the left and right ears, and the cognitive ability of the driver P for sound image direction can be trained.

In addition, in the first embodiment, the vehicle notification apparatus 23 may include the state detection unit 315 that detects the face direction of the driver P. The notification control unit 314 may change the mode of at least one of the notification sound and the face direction instruction based on the relationship between the sound image direction of the notification sound and the face direction of the driver P.

Accordingly, since the mode of at least one of the notification sound and the face direction instruction can be changed to a mode based on the sound image direction and the face direction of the driver P, it is possible to cause learning of the directional cognitive degree to be effectively performed.

In addition, in the first embodiment, the notification control unit 314 may extend the output time of the notification sound when the sound image direction of the notification sound and the face direction of the drive P are not substantially aligned within the predetermined time after the notification sound is output.

Accordingly, by continuously making the notification sound when the driver P does not face in the sound image direction, the notification sound can be kept playing while the driver P is moving the face. This makes it easier for the driver P to grasp the sound image position. This can also cause the driver P to learn the sound image position.

In addition, in the first embodiment, the notification control unit 314 may continuously output the notification sound until the sound image direction of the notification sound and the face direction of the driver P are substantially aligned.

Accordingly, by continuously making the notification sound until the driver P faces in the sound image direction, the notification sound can be kept playing while the driver P is moving the face. This makes it easier for the driver P to grasp the sound image position. This can also cause the driver P to learn the sound image position.

In addition, in the first embodiment, the notification control unit 314 may again output the face direction instruction with its mode changed when the sound image direction of the notification sound and the face direction of the driver P are not substantially aligned within the predetermined time after the notification sound is output.

Accordingly, when the driver P does not face in the sound image direction of the notification sound, it is possible to urge the driver P to face in the sound image direction of the notification sound by changing the instruction mode.

In addition, in the first embodiment, the vehicle notification apparatus 23 may include the cognitive degree determination unit 316 that determines the directional cognitive degree of the driver P to the notification sound. The notification control unit 314 may change the mode of at least one of the notification sound and the face direction instruction when the directional cognitive degree determined by the cognitive degree determination unit 316 is equal to or higher than the predetermined threshold.

Accordingly, by changing the mode of at least one of the notification sound and the face direction instruction when the directional cognitive degree is equal to or higher than the predetermined threshold, annoyance can be reduced.

In addition, in the first embodiment, the notification control unit 314 may output the notification sound without outputting the face direction instruction when the directional cognitive degree determined by the cognitive degree determination unit 316 is equal to or higher than the predetermined threshold.

Accordingly, by not providing the face direction instruction when the directional cognitive degree is equal to or higher than the predetermined threshold, annoyance caused by a directional instruction can be reduced. In addition, since the output of the notification sound is performed, it is possible to cause the driver P to periodically perform learning of the directional cognitive degree and prevent reduction in directional recognition during risk notifications.

In addition, in the first embodiment, the notification control unit 314 may change the length of the output time of the notification sound when the directional cognitive degree determined by the cognitive degree determination unit 316 is equal to or higher than the predetermined threshold.

Accordingly, by shortening the notification sound when the directional cognitive degree is equal to or higher than the predetermined threshold, annoyance can be reduced without unnecessary notification sounds.

In addition, in the first embodiment, the notification control unit 314 may reduce the frequency of outputting the notification sound when the directional cognitive degree determined by the cognitive degree determination unit 316 is equal to or higher than the predetermined threshold.

Accordingly, when the directional cognitive degree is equal to or higher than the predetermined threshold, annoyance can be reduced by reducing the frequency of directional cognitive training.

In addition, in the first embodiment, the cognitive degree determination unit 316 may determine the directional cognitive degree based on the elapsed time from when the notification sound is output to when the sound image direction of the notification sound and the face direction of the driver P are substantially aligned.

Accordingly, since a reaction becomes fast when the driver P can cognize the sound image direction of the notification sound, the directional cognitive degree can be effectively determined by using the reaction time.

In addition, in the first embodiment, the cognitive degree determination unit 316 may determine the directional cognitive degree based on the face direction angle of the driver P when the sound image direction of the notification sound and the face direction of the driver P are substantially aligned.

Accordingly, since the degree of alignment between the face direction and the sound image direction increases when the driver P can accurately cognize the sound image direction of the notification sound, the directional cognitive degree can be effectively determined by using the angle.

Note that although, in the present embodiment, the above notification conditions are described as examples, the notification sound may be output when another notification condition is established. For example, the notification condition may be that the distance to the destination reaches a predetermined value, and a notification sound with the destination direction set as the sound image direction may be output.

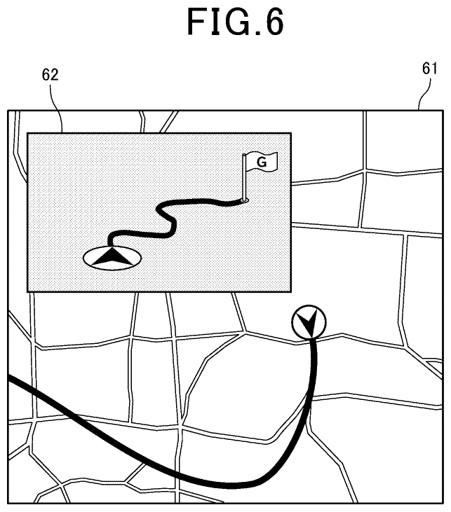

On a navigation screen, since the position of the vehicle 1 may be displayed moving on a map with fixed directions, the direction of the destination recognized by the driver P may differ from the direction of the destination on the map. FIG. 6 is an explanatory diagram showing a display example of the navigation screen. For example, on a map of the navigation screen 61, the vehicle 1 traveling facing the lower left (south-southwest) is shown. When a notification sound with the destination direction set as the sound image direction is output in this state, while the notification sound that forms the sound image direction forward of the driver P is output, the vehicle 1 traveling facing the lower left (south-southwest) is shown on the map. Thus, the driver P may feel a sense of discomfort. Thus, in outputting the notification sound, a pop-up screen 62 with the traveling direction of the vehicle 1 directed upward may be displayed, and a route from the current position of the vehicle 1 to the destination may be displayed on the pop-up screen 62. Accordingly, since both the sound image direction formed by the notification sound and the destination direction on the pop-up screen 62 are made forward of the driver P, it is possible to align the sound image direction of the notification sound with the destination direction on the navigation screen, and more efficiently improve the directional cognitive degree. The display of the pop-up screen 62 may be performed as the face direction instruction.

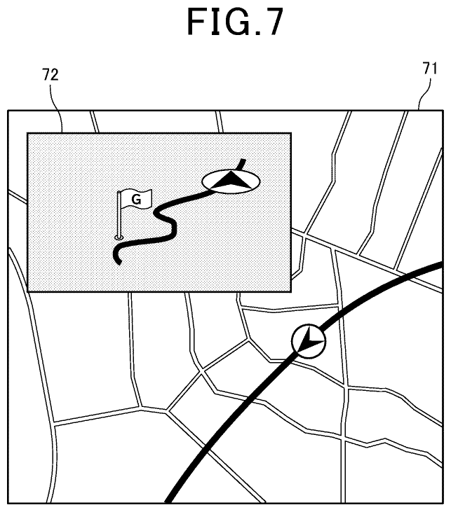

In addition, the same applies to a case in which the vehicle 1 has gone past the destination. FIG. 7 is an explanatory diagram showing a display example of the navigation screen. For example, on a map of a navigation screen 71, the vehicle 1 traveling facing the lower left (south-southwest) is shown. When a notification sound with the destination direction set as the sound image direction is output in this state, while the notification sound that forms the sound image direction rearward of the driver P is output, the vehicle 1 traveling facing the lower left (south-southwest) though the destination is in the upper right direction is shown on the map. Thus, the driver P may feel a sense of discomfort. Thus, in outputting the notification sound, a pop-up screen 72 with the traveling direction of the vehicle 1 directed upward may be displayed, and a route from the current position of the vehicle 1 to the destination may be displayed on the pop-up screen 72. Accordingly, since both the sound image direction formed by the notification sound and the destination direction on the pop-up screen 72 are made rearward of the driver P, it is possible to align the sound image direction of the notification sound with the destination direction on the navigation screen, and more efficiently improve the directional cognitive degree. The display of the pop-up screen 72 may be performed as the face direction instruction.

When a navigation screen on which the position of the vehicle 1 is displayed moving on a map with directions unfixed and with the traveling direction of the vehicle 1 fixed upward of the screen is used, since the direction of the destination is often forward, the sound image direction of the notification sound and the destination direction on the map are likely to be aligned. Thus, it is not necessary to display a pop-up screen when the notification sound is output.

In addition, in the present embodiment, when the sound image direction of the notification sound and the face direction of the driver P are not substantially aligned within the predetermined time after the notification sound is output, the output time of the notification sound is extended until the sound image direction of the notification sound and the face direction of the driver P are substantially aligned. However, this is not a limitation. For example, when the sound image direction of the notification sound and the face direction of the driver P are not substantially aligned within the predetermined time after the notification sound is output, the output time of the notification sound may be extended, and when a further certain period of time elapses, the output of the notification sound may be finished.

In addition, although, in the present embodiment, the notification sound and the alarm sound have different tones, this is not a limitation. For example, when a sound having the same tone as or a similar tone to the alarm sound is output as the notification sound, it is possible to improve the directional cognitive ability of the occupant, assuming alarm sound output. Specifically, an alarm sound with the frequency set to 300 to 1000 Hz, the number of sounding repetitions set to three times, and the number of times of sounding per second set to twice can be output, and a notification sound with the frequency set to 300 to 1000 Hz, the number of sounding repetitions set to once, and the number of times of sounding per second set to once may be output.

In addition, in the present embodiment, the vehicle notification apparatus 23 collectively determines the directional cognitive degree for all directions. However, the directional cognitive degree for each direction may be set, and for example, the directional cognitive degree for the forward direction and the directional cognitive degree for the rearward direction may be separately determined. Specifically, the vehicle notification apparatus 23 may determine the directional cognitive degree for the forward direction based on the occupant's reaction (the elapsed time, the angle) to the notification sound that forms the sound image direction in the destination direction. In addition, the vehicle notification apparatus 23 may output a notification sound such as “danger!” or “rustle” from behind the vehicle 1 after the vehicle 1 is parked in a parking lot or the like with the traveling direction set rearward (in R range), and may determine the directional cognitive degree for the rear-front direction based on the occupant's reaction to the notification sound (the elapsed time, the angle).

In addition, in the present embodiment, when the directional cognitive degree of the driver P is improved, the frequency of outputting the notification sound is reduced, the output time of the notification sound is shortened, or the presence or absence of the execution of the face direction instruction is changed. However, this is not a limitation. For example, when the directional cognitive degree of the driver P is improved, the driver P may be instructed to indicate, as an answer, the sound image direction formed by the notification sound.

In addition, although, in the present embodiment, the notification sound is output when the above-mentioned notification conditions are established, this is not a limitation. For example, on the condition that the amount of remaining gasoline is less than a predetermined value, a voice reading aloud information about a nearby gas station may be output as the notification sound so as to form the sound image direction in the direction of the nearby gas station.

In addition, in the present embodiment, the vehicle notification apparatus 23 included in the vehicle 1 is configured to have the functions as the object detection unit 311, the recognition unit 312, the alarm control unit 313, the notification control unit 314, the state detection unit 315, and the cognitive degree determination unit 316. However, this is not a limitation. For example, a system may include the vehicle 1 and an external device capable of communicating with the vehicle 1, and the external device may have some of the functions of the object detection unit 311, the recognition unit 312, the alarm control unit 313, the notification control unit 314, the state detection unit 315, and the cognitive degree determination unit 316 and the vehicle 1 may have the other functions.

In addition, although, in the description of the present embodiment, the vehicle notification apparatus 23 is provided on a four-wheeled vehicle, the vehicle notification apparatus 23 may be provided on a two-wheeled vehicle.

### 4. Configurations Supported by the Above Embodiment

The above embodiment supports the following configurations.

(Configuration 1) A vehicle notification apparatus including: an object detection unit that detects an object around a vehicle; a recognition unit that recognizes, when an object is detected by the object detection unit, a direction of the object; an alarm control unit that controls a notification unit disposed in a vehicle cabin, and outputs an alarm sound that forms a sound image direction substantially aligned with the direction of the object recognized by the recognition unit; and a notification control unit capable of outputting a notification sound that forms a sound image in a predetermined direction when no object is detected by the object detection unit, and outputting a face direction instruction that instructs an occupant to turn the face in the sound image direction of the notification sound during the output of the notification sound.

According to the vehicle notification apparatus of configuration 1, the occupant moves the head when the notification sound is playing by providing an instruction to turn the face in the sound image direction of the notification sound that notifies direction using the sound image. This makes it possible to improve the learning effect of directional cognitive degree.

(Configuration 2) The vehicle notification apparatus according to configuration 1, further including a state detection unit that detects a face direction of the occupant, in which the notification control unit changes a mode of at least one of the notification sound and the face direction instruction based on a relationship between the sound image direction of the notification sound and the face direction of the occupant.

According to the vehicle notification apparatus of configuration 2, since the mode of at least one of the notification sound and the face direction instruction can be changed to a mode based on the sound image direction and the face direction of the occupant, it is possible to cause learning of the directional cognitive degree to be effectively performed.

(Configuration 3) The vehicle notification apparatus according to configuration 2, in which the notification control unit extends an output time of the notification sound when the sound image direction of the notification sound and the face direction of the occupant are not substantially aligned within a predetermined time after the notification sound is output.

According to the vehicle notification apparatus of configuration 3, by continuously making the notification sound when the occupant does not face in the sound image direction, the notification sound can be kept playing while the occupant is moving the face. This makes it easier for the occupant to grasp the sound image position. This can also cause the occupant to learn the sound image position.

(Configuration 4) The vehicle notification apparatus according to configuration 3, in which the notification control unit continuously outputs the notification sound until the sound image direction of the notification sound and the face direction of the occupant are substantially aligned.

According to the vehicle notification apparatus of configuration 4, by continuously making the notification sound until the occupant faces in the sound image direction, the notification sound can be kept playing while the occupant is moving the face. This makes it easier for the occupant to grasp the sound image position. This can also cause the occupant to learn the sound image position.

(Configuration 5) The vehicle notification apparatus according to configuration 2, in which the notification control unit again outputs the face direction instruction with the mode changed when the sound image direction of the notification sound and the face direction of the occupant are not substantially aligned within a predetermined time after the notification sound is output.

According to the vehicle notification apparatus of configuration 5, when the occupant does not face in the sound image direction of the notification sound, it is possible to urge the occupant to face in the sound image direction of the notification sound by changing the instruction mode.

(Configuration 6) The vehicle notification apparatus according to configuration 1, further including a cognitive degree determination unit that determines a directional cognitive degree of the occupant to the notification sound, in which the notification control unit changes a mode of at least one of the notification sound and the face direction instruction when the directional cognitive degree determined by the cognitive degree determination unit is equal to or higher than a predetermined threshold.

According to the vehicle notification apparatus of configuration 6, by changing the mode of at least one of the notification sound and the face direction instruction when the directional cognitive degree is equal to or higher than the predetermined threshold, annoyance can be reduced.

(Configuration 7) The vehicle notification apparatus according to configuration 6, in which the notification control unit outputs the notification sound without outputting the face direction instruction when the directional cognitive degree determined by the cognitive degree determination unit is equal to or higher than the predetermined threshold.

According to the vehicle notification apparatus of configuration 7, by not providing the face direction instruction when the directional cognitive degree is equal to or higher than the predetermined threshold, annoyance caused by a directional instruction can be reduced. In addition, since the output of the notification sound is performed, it is possible to cause the occupant to periodically perform learning of the directional cognitive degree and prevent reduction in directional recognition during risk notifications.

(Configuration 8) The vehicle notification apparatus according to configuration 6, in which the notification control unit changes a length of an output time of the notification sound when the directional cognitive degree determined by the cognitive degree determination unit is equal to or higher than the predetermined threshold.

According to the vehicle notification apparatus of configuration 8, by shortening the notification sound when the directional cognitive degree is equal to or higher than the predetermined threshold, annoyance can be reduced without unnecessary notification sounds.

(Configuration 9) The vehicle notification apparatus according to configuration 6, in which the notification control unit reduces a frequency of outputting the notification sound when the directional cognitive degree determined by the cognitive degree determination unit is equal to or higher than the predetermined threshold.

According to the vehicle notification apparatus of configuration 9, when the directional cognitive degree is equal to or higher than the predetermined threshold, annoyance can be reduced by reducing the frequency of directional cognitive training.

(Configuration 10) The vehicle notification apparatus according to configuration 6, in which the cognitive degree determination unit determines the directional cognitive degree based on an elapsed time from when the notification sound is output to when the sound image direction of the notification sound and the face direction of the occupant are substantially aligned.

According to the vehicle notification apparatus of configuration 10, since a reaction becomes fast when the occupant can cognize the sound image direction of the notification sound, the directional cognitive degree can be effectively determined by using the reaction time.

(Configuration 11) The vehicle notification apparatus according to configuration 6, in which the cognitive degree determination unit determines the directional cognitive degree based on a face direction angle of the occupant when the sound image direction of the notification sound and the face direction of the occupant are substantially aligned.

According to the vehicle notification apparatus of configuration 11, since the degree of alignment between the face direction and the sound image direction increases when the occupant can accurately cognize the sound image direction of the notification sound, the directional cognitive degree can be effectively determined by using the angle.

(Configuration 12) A vehicle notification method executed by a computer of a vehicle notification apparatus, the vehicle notification method including: an object detection step of detecting an object around a vehicle; a recognition step of recognizing, when an object is detected in the object detection step, a direction of the object; an alarm control step of controlling a notification unit disposed in a vehicle cabin, and outputting an alarm sound that forms a sound image direction substantially aligned with the direction of the object recognized in the recognition step; and a notification control step capable of outputting a notification sound that forms a sound image in a predetermined direction when no object is detected in the object detection step, and outputting a face direction instruction that instructs an occupant to turn the face in the sound image direction of the notification sound during the output of the notification sound.

The vehicle notification method of configuration 12achieves the same effects as the vehicle notification apparatus of configuration 1.

(Configuration 13) A vehicle notification system including: an object detection unit that detects an object around a vehicle; a recognition unit that recognizes, when an object is detected by the object detection unit, a direction of the object; an alarm control unit that controls a notification unit disposed in a vehicle cabin, and outputs an alarm sound that forms a sound image direction substantially aligned with the direction of the object recognized by the recognition unit; and a notification control unit capable of outputting a notification sound that forms a sound image in a predetermined direction when no object is detected by the object detection unit, and outputting a face direction instruction that instructs an occupant to turn the face in the sound image direction of the notification sound during the output of the notification sound.

The vehicle notification system of configuration 13 achieves the same effects as the vehicle notification apparatus of configuration 1.

### REFERENCE SIGNS LIST

1 vehicle, 10A driver's seat, 10B front passenger seat, 10C rear right seat, 10D rear left seat, 12 touch panel, 13 speaker, 14 speaker, 15 speaker, 16 speaker, 17 speaker, 18 front camera, 19 ambient light, 22 monitor camera, 23 vehicle notification apparatus, 25 GPS device, 26 navigation device, 31 processor, 32 memory, 61 navigation screen, 62 pop-up screen, 71 navigation screen, 72 pop-up screen, 311 object detection unit, 312 recognition unit, 313 alarm control unit, 314 notification control unit, 315 state detection unit, 316 cognitive degree determination unit, 321 control program, HD head, P driver.

1. A vehicle notification apparatus comprising:
an object detection unit that detects an object around a vehicle;
a recognition unit that recognizes, when an object is detected by the object detection unit, a direction of the object;
an alarm control unit that controls a notification unit disposed in a vehicle cabin, and outputs an alarm sound that forms a sound image direction substantially aligned with the direction of the object recognized by the recognition unit; and
a notification control unit capable of outputting a notification sound that forms a sound image in a predetermined direction when no object is detected by the object detection unit, and outputting a face direction instruction that instructs an occupant to turn the face in the sound image direction of the notification sound during the output of the notification sound.

2. The vehicle notification apparatus according to claim 1, further comprising a state detection unit that detects a face direction of the occupant, wherein
the notification control unit changes a mode of at least one of the notification sound and the face direction instruction based on a relationship between the sound image direction of the notification sound and the face direction of the occupant.

3. The vehicle notification apparatus according to claim 2, wherein the notification control unit extends an output time of the notification sound when the sound image direction of the notification sound and the face direction of the occupant are not substantially aligned within a predetermined time after the notification sound is output.

4. The vehicle notification apparatus according to claim 3, wherein the notification control unit continuously outputs the notification sound until the sound image direction of the notification sound and the face direction of the occupant are substantially aligned.

5. The vehicle notification apparatus according to claim 2, wherein the notification control unit again outputs the face direction instruction with the mode changed when the sound image direction of the notification sound and the face direction of the occupant are not substantially aligned within a predetermined time after the notification sound is output.

6. The vehicle notification apparatus according to claim 1, further comprising a cognitive degree determination unit that determines a directional cognitive degree of the occupant to the notification sound, wherein
the notification control unit changes a mode of at least one of the notification sound and the face direction instruction when the directional cognitive degree determined by the cognitive degree determination unit is equal to or higher than a predetermined threshold.

7. The vehicle notification apparatus according to claim 6, wherein the notification control unit outputs the notification sound without outputting the face direction instruction when the directional cognitive degree determined by the cognitive degree determination unit is equal to or higher than the predetermined threshold.

8. The vehicle notification apparatus according to claim 6, wherein the notification control unit changes a length of an output time of the notification sound when the directional cognitive degree determined by the cognitive degree determination unit is equal to or higher than the predetermined threshold.

9. The vehicle notification apparatus according to claim 6, wherein the notification control unit reduces a frequency of outputting the notification sound when the directional cognitive degree determined by the cognitive degree determination unit is equal to or higher than the predetermined threshold.

10. The vehicle notification apparatus according to claim 6, wherein the cognitive degree determination unit determines the directional cognitive degree based on an elapsed time from when the notification sound is output to when the sound image direction of the notification sound and the face direction of the occupant are substantially aligned.

11. The vehicle notification apparatus according to claim 6, wherein the cognitive degree determination unit determines the directional cognitive degree based on a face direction angle of the occupant when the sound image direction of the notification sound and the face direction of the occupant are substantially aligned.

12. A vehicle notification method executed by a computer of a vehicle notification apparatus, the vehicle notification method comprising:
an object detection step of detecting an object around a vehicle;
a recognition step of recognizing, when an object is detected in the object detection step, a direction of the object;
an alarm control step of controlling a notification unit disposed in a vehicle cabin, and outputting an alarm sound that forms a sound image direction substantially aligned with the direction of the object recognized in the recognition step; and
a notification control step capable of outputting a notification sound that forms a sound image in a predetermined direction when no object is detected in the object detection step, and outputting a face direction instruction that instructs an occupant to turn the face in the sound image direction of the notification sound during the output of the notification sound.

13. A vehicle notification system comprising:
an object detection unit that detects an object around a vehicle;
a recognition unit that recognizes, when an object is detected by the object detection unit, a direction of the object;
an alarm control unit that controls a notification unit disposed in a vehicle cabin, and outputs an alarm sound that forms a sound image direction substantially aligned with the direction of the object recognized by the recognition unit; and
a notification control unit capable of outputting a notification sound that forms a sound image in a predetermined direction when no object is detected by the object detection unit, and outputting a face direction instruction that instructs an occupant to turn the face in the sound image direction of the notification sound during the output of the notification sound.
